(19) United States
(12) Patent Application Publication
(10) Pub. No.: US 2026/0283204 A1
(43) Pub. Date: Sep. 24, 2026

(54) PRODUCTION PROCESS FOR SOW THISTLE

(71) Applicant: Yan'an University, Yan'an (CN)

(72) Inventors: Fei JIA, Yan'an (CN); Runmei LI, Yan'an (CN)

(21) Appl. No.: 19/194,552

(22) Filed: Apr. 30, 2025

(30) Foreign Application Priority Data
Mar. 18, 2025 (CN) 202510316845.X

(51) Int. Cl. A23L 19/20; A23L 5/10; A23L 5/20

(52) U.S. Cl. CPC A23L 19/20; A23L 5/10; A23L 5/20

(57) ABSTRACT

The invention discloses a production process for sow thistle, including the following steps: step 1: collection and trimming of raw material; step 2: cleaning of raw material; step 3: blanching of raw material; step 4: dehydration of raw material; step 5: preparation of ingredients; step 6: salting; and step 7: low-temperature pickling. The production process of the invention is simple to operate, changes the prior art methods with complicated operation steps, saves time and production costs, simplifies the process, and is suitable for industrial production. Moreover, the production process of the invention does not use any preservatives, and adopts a production process of low-salt and low-temperature pickling, thereby avoiding excessive waste of water resources and also protecting the environment.

### CROSS-REFERENCE TO RELATED APPLICATIONS

The present application claims priority to Chinese Patent Application No. 202510316845.X, filed on Mar. 18, 2025, the entire disclosure of which is incorporated herein by reference.

### TECHNICAL FIELD

The present invention relates to the technical field of sow thistle pickling and, in particular, to a production process for sow thistle.

### BACKGROUND

Sow thistle, first recorded in the “Shennong's Herbal Classic”, belongs to the genus Sonchus of the Compositae. Also known as Sonchus oleraceus, Sonchus endive, etc., sow thistle is a medicinal and edible plant and a natural green vegetable. Wild sow thistle is pollution-free and has extremely high nutritional value. Most of sow thistle plants are wild and grow in most areas of China. They can be found in uncultivated land, fields, mountainous and wild areas, etc. China's folk consumption of sow thistle has a long history of more than 2,000 years, and the culture of eating sow thistle has gradually formed. In the past, when the poor labors were starving because of no food, they had to eat sow thistle to stave off starvation. People living in the Loess Plateau also called sow thistle a “life-saving dish” in lean years, a “regular dish” in bumper years, and an indispensable delicacy on the table. According to reports, the Red Army also dug sow thistle to satisfy their hunger during the Long March. So sow thistle were praised as “Red Army dish” and “glorious dish.”

Sow thistle is rich in nutrients and physiologically active substances, such as 8 amino acids essential to the human body, and has high nutritional value and health care effects.

The processes for pickling sow thistle disclosed in Chinese Patents CN106333304A and CN106616670A mainly include the following steps: pretreatment of sow thistle→cleaning→trimming→blanching→color protection→salting→desalting→packaging.

The processes for pickling sow thistle disclosed in Chinese Patent CN106235157A mainly includes the following steps: pretreatment of sow thistle→salting→re-salting→packaging.

The process for pickling sow thistle disclosed in Chinese Patent CN106235157A mainly includes the following steps: raw material collection treatment→blanching treatment→juice removal→soaking treatment→baking treatment→semi-finished products.

However, the conventional production methods have the following shortcomings: many operations and complex process steps are involved, which is not suitable for large-scale industrial production; excessive use of preservatives endangers health; due to the use of high-salt salting, a large amount of clear water is required for desalting during production, resulting in serious waste of water resources; moreover, a large amount of sewage is discharged, causing pollution to the environment; operations such as repeated pickling, repeated cleaning, and re-processing will also cause serious loss of nutrients in sow thistle.

Therefore, a technical problem that needs to be solved urgently by the present invention is to provide a technology of which the production process is simple to operate, changes the prior art methods with complicated operation steps, saves time and production costs, simplifies the process, and is suitable for industrial production. Moreover, the production process does not use any preservatives. The production process of low-salt and low-temperature pickling is adopted, thereby avoiding excessive waste of water resources and also protecting the environment.

### SUMMARY OF THE INVENTION

In view of this, the present invention provides a production process for sow thistle.

To solve the above technical problems, the present invention takes the following technical solution:

A production process for sow thistle includes the following steps:
step S1: collection and trimming of raw material
collecting sow thistle, picking fresh, tender and fat sow thistle leaves, and removing the roots and parts with the soil; and removing weeds and dead, yellow and sick leaves mixed in the collected sow thistle leaves to obtain trimmed sow thistle leaves for later use;
step S2: cleaning of raw material
soaking and cleaning the trimmed sow thistle leaves with clear water;
step S3 blanching of raw material
boiling the cleaned sow thistle leaves in a hot water bath, then taking the boiled sow thistle leaves out and soaking in water, cooling naturally, and draining the water;
step S4: dehydration of raw material
squeezing the blanched sow thistle leaves until no water flows out, and then drying the sow thistle leaves with hot air;
step S5: preparation of ingredients
peeling and washing the garlic and washing and shredding carrots for later use;
washing and slicing ginger for later use;
step S6: salting
placing the dehydrated sow thistle leaves in a container, adding salt to pickle the sow thistle leaves, and then adding the garlic, shredded carrots and ginger slices, and storing the salted sow thistle leaves with ventilation;
step S7: low-temperature pickling
re-pickling the pickled sow thistle at a low temperature.

Preferably, in step S1, sow thistle with a length of 8 to 12 cm is collected.

Preferably, in step S3, the temperature of the hot water bath is between 60° C. and 80° C., the boiling time is 5-10 min, and the time of soaking in water is 0.5-1 h.

Preferably, in step S4, the sow thistle leaves are dried with 50° C.-60° C. hot air for 1-2 h.

Preferably, in step S6, the amount of salt added is 4% to 10% of the weight of sow thistle, the amount of garlic added is 0.03% to 0.05% of the weight of sow thistle, the amount of shredded carrots added is 0.04% to 0.06% of the weight of sow thistle, and the amount of ginger slices added is 0.05% to 0.08% of the weight of sow thistle.

Preferably, in step S7, the sow thistle is pickled at a temperature of 6° C.-10° C. for 2-3 months.

Compared with the prior art, the present invention achieves the following technical effects:
(1) The production process of the present invention is simple to operate, changes the prior art methods with complicated operation steps, saves time and production costs, simplifies the process, and is suitable for industrial production.
(2) The production process of the present invention does not use any preservatives, and adopts a production process of low-salt and low-temperature pickling, thereby avoiding excessive waste of water resources and also protecting the environment.

### BRIEF DESCRIPTION OF THE DRAWINGS

FIG. 1 is a flow chart of a production process for sow thistle according to the present invention.

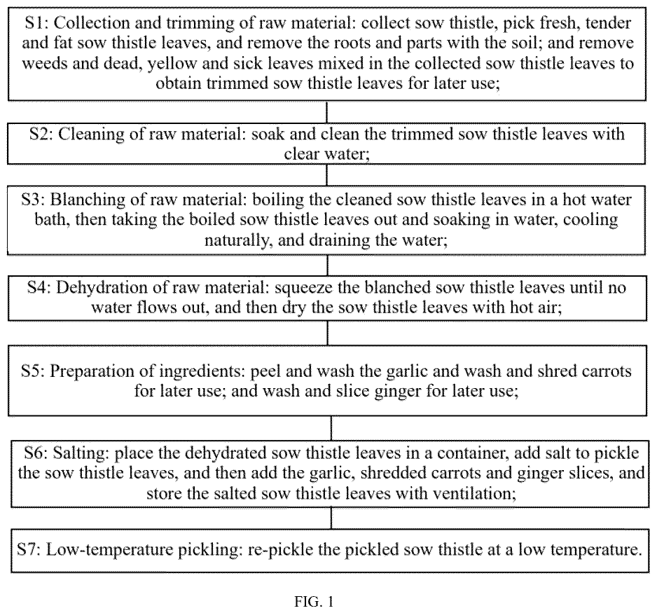

### DETAILED DESCRIPTION OF THE EMBODIMENTS

The technical solutions of the embodiments of the invention are clearly and completely described below with reference to the accompanying drawings in the embodiments of the invention. Apparently, the described embodiments are only some, but not all of the embodiments of the invention. Based on the embodiments of the invention, all other embodiments obtained by those of ordinary skill in the art without creative work fall within the scope of the invention.

The present invention discloses a production process for sow thistle, including the following steps.

### Step S1: Collection and Trimming of Raw Material

Collecting sow thistle with a length of 8 to 12 cm, picking fresh, tender and fat sow thistle leaves, and removing the roots and parts with the soil; and removing weeds and dead, yellow and sick leaves mixed in the collected sow thistle leaves to obtain trimmed sow thistle leaves for later use.

### Step S2: Cleaning of Raw Material

Soaking and cleaning the trimmed sow thistle leaves with clear water.

### Step S3: Blanching of Raw Material

Boiling the cleaned sow thistle leaves in a hot water bath with a temperature of 60° C.-80° C. for 5-10 min, then taking the boiled sow thistle leaves out and soaking in water for 0.5-1 h, cooling naturally, and draining the water.

### Step S4: Dehydration of Raw Material

Squeezing the blanched sow thistle leaves until no water flows out, and drying the sow thistle leaves with 50° C.-60° C. hot air for 1-2 h.

### Step S5: Preparation of Ingredients

Peeling and washing the garlic and washing and shredding carrots for later use; and washing and slicing ginger for later use.

### Step S6: Salting

Placing the dehydrated sow thistle leaves in a container, adding salt to pickle the sow thistle leaves, then adding garlic, shredded carrots and ginger slices, and storing the salted sow thistle leaves with ventilation, wherein the amount of salt added is 4% to 10% of the weight of sow thistle, the amount of garlic added is 0.03% to 0.05% of the weight of sow thistle, the amount of shredded carrots added is 0.04% to 0.06% of the weight of sow thistle, and the amount of ginger slices added is 0.05% to 0.08% of the weight of sow thistle.

### Step S7: Low-Temperature Pickling

Re-pickling the pickled sow thistle at a low temperature of 6-10° C. for 2-3 months.

### Example 1

### Step S1: Collection and Trimming of Raw Material

Collecting sow thistle with a length of 8 to 12 cm, picking fresh, tender and fat sow thistle leaves, and removing the roots and parts with the soil; and removing weeds and dead, yellow and sick leaves mixed in the collected sow thistle leaves to obtain trimmed sow thistle leaves for later use.

### Step S2: Cleaning of Raw Material

Soaking and cleaning the trimmed sow thistle leaves with clear water.

### Step S3: Blanching of Raw Material

Boiling the cleaned sow thistle leaves in a hot water bath with a temperature of 60° C. for 10 min, then taking the boiled sow thistle leaves out and soaking in water for 0.5 h, cooling naturally, and draining the water.

### Step S4: Dehydration of Raw Material

Squeezing the blanched sow thistle leaves until no water flows out, and drying the sow thistle leaves with 60° C. hot air for 2 h.

### Step S5: Preparation of Ingredients

Peeling and washing the garlic and washing and shredding carrots for later use; and washing and slicing ginger for later use.

### Step S6: Salting

Placing the dehydrated sow thistle leaves in a container, adding salt to pickle the sow thistle leaves, then adding garlic, shredded carrots and ginger slices, and storing the salted sow thistle leaves with ventilation, wherein the amount of salt added is 4% of the weight of sow thistle, the amount of garlic added is 0.03% of the weight of sow thistle, the amount of shredded carrots added is 0.04% of the weight of sow thistle, and the amount of ginger slices added is 0.05% of the weight of sow thistle.

### Step S7: Low-Temperature Pickling

Re-pickling the pickled sow thistle at a low temperature of 6° C.-10° C. for 2 months.

### Example 2

### Step S1: Collection and Trimming of Raw Material

Collecting sow thistle with a length of 8 to 12 cm, picking fresh, tender and fat sow thistle leaves, and removing the roots and parts with the soil; and removing weeds and dead, yellow and sick leaves mixed in the collected sow thistle leaves to obtain trimmed sow thistle leaves for later use.

### Step S2: Cleaning of Raw Material

Soaking and cleaning the trimmed sow thistle leaves with clear water.

### Step S3: Blanching of Raw Material

Boiling the cleaned sow thistle leaves in a hot water bath with a temperature of 70° C. for 10 min, then taking the boiled sow thistle leaves out and soaking in water for 0.5 h, cooling naturally, and draining the water.

### Step S4: Dehydration of Raw Material

Squeezing the blanched sow thistle leaves until no water flows out, and drying the sow thistle leaves with 60° C. hot air for 2 h.

### Step S5: Preparation of Ingredients

Peeling and washing the garlic and washing and shredding carrots for later use; and washing and slicing ginger for later use.

### Step S6: Salting

Placing the dehydrated sow thistle leaves in a container, adding salt to pickle the sow thistle leaves, then adding garlic, shredded carrots and ginger slices, and storing the salted sow thistle leaves with ventilation, wherein the amount of salt added is 4% of the weight of sow thistle, the amount of garlic added is 0.03% of the weight of sow thistle, the amount of shredded carrots added is 0.04% of the weight of sow thistle, and the amount of ginger slices added is 0.05% of the weight of sow thistle.

### Step S7: Low-Temperature Pickling

Re-pickling the pickled sow thistle at a low temperature of 6° C.-10° C. for 2 months.

### Example 3

### Step S1: Collection and Trimming of Raw Material

Collecting sow thistle with a length of 8 to 12 cm, picking fresh, tender and fat sow thistle leaves, and removing the roots and parts with the soil; and removing weeds and dead, yellow and sick leaves mixed in the collected sow thistle leaves to obtain trimmed sow thistle leaves for later use.

### Step S2: Cleaning of Raw Material

Soaking and cleaning the trimmed sow thistle leaves with clear water.

### Step S3: Blanching of Raw Material

Boiling the cleaned sow thistle leaves in a hot water bath with a temperature of 80° C. for 10 min, then taking the boiled sow thistle leaves out and soaking in water for 0.5 h, cooling naturally, and draining the water.

### Step S4: Dehydration of Raw Material

Squeezing the blanched sow thistle leaves until no water flows out, and drying the sow thistle leaves with 60° C. hot air for 2 h.

### Step S5: Preparation of Ingredients

Peeling and washing the garlic and washing and shredding carrots for later use; and washing and slicing ginger for later use.

### Step S6: Salting

Placing the dehydrated sow thistle leaves in a container, adding salt to pickle the sow thistle leaves, then adding garlic, shredded carrots and ginger slices, and storing the salted sow thistle leaves with ventilation, wherein the amount of salt added is 4% of the weight of sow thistle, the amount of garlic added is 0.03% of the weight of sow thistle, the amount of shredded carrots added is 0.04% of the weight of sow thistle, and the amount of ginger slices added is 0.05% of the weight of sow thistle.

### Step S7: Low-Temperature Pickling

Re-pickling the pickled sow thistle at a low temperature of 6° C.-10° C. for 2 months.

### Example 4

### Step S1: Collection and Trimming of Raw Material

Collecting sow thistle with a length of 8 to 12 cm, picking fresh, tender and fat sow thistle leaves, and removing the roots and parts with the soil; and removing weeds and dead, yellow and sick leaves mixed in the collected sow thistle leaves to obtain trimmed sow thistle leaves for later use.

### Step S2: Cleaning of Raw Material

Soaking and cleaning the trimmed sow thistle leaves with clear water.

### Step S3: Blanching of Raw Material

Boiling the cleaned sow thistle leaves in a hot water bath with a temperature of 80° C. for 10 min, then taking the boiled sow thistle leaves out and soaking in water for 0.5 h, cooling naturally, and draining the water.

### Step S4: Dehydration of Raw Material

Squeezing the blanched sow thistle leaves until no water flows out, and drying the sow thistle leaves with 60° C. hot air for 2 h.

### Step S5: Preparation of Ingredients

Peeling and washing the garlic and washing and shredding carrots for later use; and washing and slicing ginger for later use.

### Step S6: Salting

Placing the dehydrated sow thistle leaves in a container, adding salt to pickle the sow thistle leaves, then adding garlic, shredded carrots and ginger slices, and storing the salted sow thistle leaves with ventilation, wherein the amount of salt added is 10% of the weight of sow thistle, the amount of garlic added is 0.05% of the weight of sow thistle, the amount of shredded carrots added is 0.06% of the weight of sow thistle, and the amount of ginger slices added is 0.08% of the weight of sow thistle.

### Step S7: Low-Temperature Pickling

Re-pickling the pickled sow thistle at a low temperature of 6° C.-10° C. for 2 months.

### Example 5

### Step S1: Collection and Trimming of Raw Material

Collecting sow thistle with a length of 8 to 12 cm, picking fresh, tender and fat sow thistle leaves, and removing the roots and parts with the soil; and removing weeds and dead, yellow and sick leaves mixed in the collected sow thistle leaves to obtain trimmed sow thistle leaves for later use.

### Step S2: Cleaning of Raw Material

Soaking and cleaning the trimmed sow thistle leaves with clear water.

### Step S3: Blanching of Raw Material

Boiling the cleaned sow thistle leaves in a hot water bath with a temperature of 80° C. for 10 min, then taking the boiled sow thistle leaves out and soaking in water for 0.5 h, cooling naturally, and draining the water.

### Step S4: Dehydration of Raw Material

Squeezing the blanched sow thistle leaves until no water flows out, and drying the sow thistle leaves with 60° C. hot air for 2 h.

### Step S5: Preparation of Ingredients

Peeling and washing the garlic and washing and shredding carrots for later use; and washing and slicing ginger for later use.

### Step S6: Salting

Placing the dehydrated sow thistle leaves in a container, adding salt to pickle the sow thistle leaves, then adding garlic, shredded carrots and ginger slices, and storing the salted sow thistle leaves with ventilation, wherein the amount of salt added is 10% of the weight of sow thistle, the amount of garlic added is 0.05% of the weight of sow thistle, the amount of shredded carrots added is 0.06% of the weight of sow thistle, and the amount of ginger slices added is 0.08% of the weight of sow thistle.

### Step S7: Low-Temperature Pickling

Re-pickling the pickled sow thistle at a low temperature of 6° C.-10° C. for 3 months.

### Example 6

### Step S1: Collection and Trimming of Raw Material

Collecting sow thistle with a length of 8 to 12 cm, picking fresh, tender and fat sow thistle leaves, and removing the roots and parts with the soil; and removing weeds and dead, yellow and sick leaves mixed in the collected sow thistle leaves to obtain trimmed sow thistle leaves for later use.

### Step S2: Cleaning of Raw Material

Soaking and cleaning the trimmed sow thistle leaves with clear water.

### Step S3: Blanching of Raw Material

Boiling the cleaned sow thistle leaves in a hot water bath with a temperature of 70° C. for 10 min, then taking the boiled sow thistle leaves out and soaking in water for 0.5 h, cooling naturally, and draining the water.

### Step S4: Dehydration of Raw Material

Squeezing the blanched sow thistle leaves until no water flows out, and drying the sow thistle leaves with 60° C. hot air for 2 h.

### Step S5: Preparation of Ingredients

Peeling and washing the garlic and washing and shredding carrots for later use; and washing and slicing ginger for later use.

### Step S6: Salting

Placing the dehydrated sow thistle leaves in a container, adding salt to pickle the sow thistle leaves, then adding garlic, shredded carrots and ginger slices, and storing the salted sow thistle leaves with ventilation, wherein the amount of salt added is 7% of the weight of sow thistle, the amount of garlic added is 0.04% of the weight of sow thistle, the amount of shredded carrots added is 0.05% of the weight of sow thistle, and the amount of ginger slices added is 0.06% of the weight of sow thistle.

### Step S7: Low-Temperature Pickling

Re-pickling the pickled sow thistle at a low temperature of 6° C.-10° C. for 2 months.

### Example 7

### Step S1: Collection and Trimming of Raw Material

Collecting sow thistle with a length of 8 to 12 cm, picking fresh, tender and fat sow thistle leaves, and removing the roots and parts with the soil; and removing weeds and dead, yellow and sick leaves mixed in the collected sow thistle leaves to obtain trimmed sow thistle leaves for later use.

### Step S2: Cleaning of Raw Material

Soaking and cleaning the trimmed sow thistle leaves with clear water.

### Step S3: Blanching of Raw Material

Boiling the cleaned sow thistle leaves in a hot water bath with a temperature of 70° C. for 10 min, then taking the boiled sow thistle leaves out and soaking in water for 0.5 h, cooling naturally, and draining the water.

### Step S4: Dehydration of Raw Material

Squeezing the blanched sow thistle leaves until no water flows out, and drying the sow thistle leaves with 60° C. hot air for 2 h.

### Step S5: Preparation of Ingredients

Peeling and washing the garlic and washing and shredding carrots for later use; and washing and slicing ginger for later use.

### Step S6: Salting

Placing the dehydrated sow thistle leaves in a container, adding salt to pickle the sow thistle leaves, then adding garlic, shredded carrots and ginger slices, and storing the salted sow thistle leaves with ventilation, wherein the amount of salt added is 7% of the weight of sow thistle, the amount of garlic added is 0.04% of the weight of sow thistle, the amount of shredded carrots added is 0.05% of the weight of sow thistle, and the amount of ginger slices added is 0.06% of the weight of sow thistle.

### Step S7: Low-Temperature Pickling

Re-pickling the pickled sow thistle at a low temperature of 6° C.-10° C. for 2 months.

### Example 8

### Step S1: Collection and Trimming of Raw Material

Collecting sow thistle with a length of 8 to 12 cm, picking fresh, tender and fat sow thistle leaves, and removing the roots and parts with the soil; and removing weeds and dead, yellow and sick leaves mixed in the collected sow thistle leaves to obtain trimmed sow thistle leaves for later use.

### Step S2: Cleaning of Raw Material

Soaking and cleaning the trimmed sow thistle leaves with clear water.

### Step S3: Blanching of Raw Material

Boiling the cleaned sow thistle leaves in a hot water bath with a temperature of 60° C. for 10 min, then taking the boiled sow thistle leaves out and soaking in water for 1 h, cooling naturally, and draining the water.

### Step S4: Dehydration of Raw Material

Squeezing the blanched sow thistle leaves until no water flows out, and drying the sow thistle leaves with 50° C. hot air for 1 h.

### Step S5: Preparation of Ingredients

Peeling and washing the garlic and washing and shredding carrots for later use; and washing and slicing ginger for later use.

### Step S6: Salting

Placing the dehydrated sow thistle leaves in a container, adding salt to pickle the sow thistle leaves, then adding garlic, shredded carrots and ginger slices, and storing the salted sow thistle leaves with ventilation, wherein the amount of salt added is 4% of the weight of sow thistle, the amount of garlic added is 0.03% of the weight of sow thistle, the amount of shredded carrots added is 0.04% of the weight of sow thistle, and the amount of ginger slices added is 0.05% of the weight of sow thistle.

### Step S7: Low-Temperature Pickling

Re-pickling the pickled sow thistle at a low temperature of 10° C. for 2 months.

### Example 9

### Step S1: Collection and Trimming of Raw Material

Collecting sow thistle with a length of 8 to 12 cm, picking fresh, tender and fat sow thistle leaves, and removing the roots and parts with the soil; and removing weeds and dead, yellow and sick leaves mixed in the collected sow thistle leaves to obtain trimmed sow thistle leaves for later use.

### Step S2: Cleaning of Raw Material

Soaking and cleaning the trimmed sow thistle leaves with clear water.

### Step S3: Blanching of Raw Material

Boiling the cleaned sow thistle leaves in a hot water bath with a temperature of 60° C. for 10 min, then taking the boiled sow thistle leaves out and soaking in water for 1 h, cooling naturally, and draining the water.

### Step S4: Dehydration of Raw Material

Squeezing the blanched sow thistle leaves until no water flows out, and drying the sow thistle leaves with 55° C. hot air for 1 h.

### Step S5: Preparation of Ingredients

Peeling and washing the garlic and washing and shredding carrots for later use; and washing and slicing ginger for later use.

### Step S6: Salting

Placing the dehydrated sow thistle leaves in a container, adding salt to pickle the sow thistle leaves, then adding garlic, shredded carrots and ginger slices, and storing the salted sow thistle leaves with ventilation, wherein the amount of salt added is 4% of the weight of sow thistle, the amount of garlic added is 0.03% of the weight of sow thistle, the amount of shredded carrots added is 0.04% of the weight of sow thistle, and the amount of ginger slices added is 0.05% of the weight of sow thistle.

### Step S7: Low-Temperature Pickling

Re-pickling the pickled sow thistle at a low temperature of 10° C. for 2 months.

### Example 10

### Step S1: Collection and Trimming of Raw Material

Collecting sow thistle with a length of 8 to 12 cm, picking fresh, tender and fat sow thistle leaves, and removing the roots and parts with the soil; and removing weeds and dead, yellow and sick leaves mixed in the collected sow thistle leaves to obtain trimmed sow thistle leaves for later use.

### Step S2: Cleaning of Raw Material

Soaking and cleaning the trimmed sow thistle leaves with clear water.

### Step S3: Blanching of Raw Material

Boiling the cleaned sow thistle leaves in a hot water bath with a temperature of 60° C. for 10 min, then taking the boiled sow thistle leaves out and soaking in water for 1 h, cooling naturally, and draining the water.

### Step S4: Dehydration of Raw Material

Squeezing the blanched sow thistle leaves until no water flows out, and drying the sow thistle leaves with 60° C. hot air for 1 h.

### Step S5: Preparation of Ingredients

Peeling and washing the garlic and washing and shredding carrots for later use; and washing and slicing ginger for later use.

### Step S6: Salting

Placing the dehydrated sow thistle leaves in a container, adding salt to pickle the sow thistle leaves, then adding garlic, shredded carrots and ginger slices, and storing the salted sow thistle leaves with ventilation, wherein the amount of salt added is 4% of the weight of sow thistle, the amount of garlic added is 0.03% of the weight of sow thistle, the amount of shredded carrots added is 0.04% of the weight of sow thistle, and the amount of ginger slices added is 0.05% of the weight of sow thistle.

### Step S7: Low-Temperature Pickling

Re-pickling the pickled sow thistle at a low temperature of 10° C. for 2 months.

### Example 11

### Step S1: Collection and Trimming of Raw Material

Collecting sow thistle with a length of 8 to 12 cm, picking fresh, tender and fat sow thistle leaves, and removing the roots and parts with the soil; and removing weeds and dead, yellow and sick leaves mixed in the collected sow thistle leaves to obtain trimmed sow thistle leaves for later use.

### Step S2: Cleaning of Raw Material

Soaking and cleaning the trimmed sow thistle leaves with clear water.

### Step S3: Blanching of Raw Material

Boiling the cleaned sow thistle leaves in a hot water bath with a temperature of 65° C. for 10 min, then taking the boiled sow thistle leaves out and soaking in water for 0.7 h, cooling naturally, and draining the water.

### Step S4: Dehydration of Raw Material

Squeezing the blanched sow thistle leaves until no water flows out, and drying the sow thistle leaves with 54° C. hot air for 2 h.

### Step S5: Preparation of Ingredients

Peeling and washing the garlic and washing and shredding carrots for later use; and washing and slicing ginger for later use.

### Step S6: Salting

Placing the dehydrated sow thistle leaves in a container, adding salt to pickle the sow thistle leaves, then adding garlic, shredded carrots and ginger slices, and storing the salted sow thistle leaves with ventilation, wherein the amount of salt added is 4% of the weight of sow thistle, the amount of garlic added is 0.03% of the weight of sow thistle, the amount of shredded carrots added is 0.04% of the weight of sow thistle, and the amount of ginger slices added is 0.05% of the weight of sow thistle.

### Step S7: Low-Temperature Pickling

Re-pickling the pickled sow thistle at a low temperature of 6° C.-10° C. for 2 months.

### Example 12

### Step S1: Collection and Trimming of Raw Material

Collecting sow thistle with a length of 8 to 12 cm, picking fresh, tender and fat sow thistle leaves, and removing the roots and parts with the soil; and removing weeds and dead, yellow and sick leaves mixed in the collected sow thistle leaves to obtain trimmed sow thistle leaves for later use.

### Step S2: Cleaning of Raw Material

Soaking and cleaning the trimmed sow thistle leaves with clear water.

### Step S3: Blanching of Raw Material

Boiling the cleaned sow thistle leaves in a hot water bath with a temperature of 65° C. for 10 min, then taking the boiled sow thistle leaves out and soaking in water for 0.7 h, cooling naturally, and draining the water.

### Step S4: Dehydration of Raw Material

Squeezing the blanched sow thistle leaves until no water flows out, and drying the sow thistle leaves with 54° C. hot air for 2 h.

### Step S5: Preparation of Ingredients

Peeling and washing the garlic and washing and shredding carrots for later use; and washing and slicing ginger for later use.

### Step S6: Salting

Placing the dehydrated sow thistle leaves in a container, adding salt to pickle the sow thistle leaves, then adding garlic, shredded carrots and ginger slices, and storing the salted sow thistle leaves with ventilation, wherein the amount of salt added is 7% of the weight of sow thistle, the amount of garlic added is 0.04% of the weight of sow thistle, the amount of shredded carrots added is 0.05% of the weight of sow thistle, and the amount of ginger slices added is 0.06% of the weight of sow thistle.

### Step S7: Low-Temperature Pickling

Re-pickling the pickled sow thistle at a low temperature of 6° C.-10° C. for 2 months.

### Example 13

### Step S1: Collection and Trimming of Raw Material

Collecting sow thistle with a length of 8 to 12 cm, picking fresh, tender and fat sow thistle leaves, and removing the roots and parts with the soil; and removing weeds and dead, yellow and sick leaves mixed in the collected sow thistle leaves to obtain trimmed sow thistle leaves for later use.

### Step S2: Cleaning of Raw Material

Soaking and cleaning the trimmed sow thistle leaves with clear water.

### Step S3: Blanching of Raw Material

Boiling the cleaned sow thistle leaves in a hot water bath with a temperature of 65° C. for 10 min, then taking the boiled sow thistle leaves out and soaking in water for 0.7 h, cooling naturally, and draining the water.

### Step S4: Dehydration of Raw Material

Squeezing the blanched sow thistle leaves until no water flows out, and drying the sow thistle leaves with 54° C. hot air for 2 h.

### Step S5: Preparation of Ingredients

Peeling and washing the garlic and washing and shredding carrots for later use; and washing and slicing ginger for later use.

### Step S6: Salting

Placing the dehydrated sow thistle leaves in a container, adding salt to pickle the sow thistle leaves, then adding garlic, shredded carrots and ginger slices, and storing the salted sow thistle leaves with ventilation, wherein the amount of salt added is 10% of the weight of sow thistle, the amount of garlic added is 0.05% of the weight of sow thistle, the amount of shredded carrots added is 0.06% of the weight of sow thistle, and the amount of ginger slices added is 0.08% of the weight of sow thistle.

### Step S7: Low-Temperature Pickling

Re-pickling the pickled sow thistle at a low temperature of 6° C.-10° C. for 2 months.

The above are only preferred embodiments of the invention and do not limit the technical scope of the invention. Therefore, any minor modifications, equivalent changes and modifications made to the above embodiments based on the technical essence of the invention still fall within the scope of the technical solution of the invention.

What is claimed is:

1. A production process for sow thistle, comprising the following steps:
step S1: collection and trimming of raw material
collecting sow thistle, picking fresh, tender and fat sow thistle leaves, and removing the roots and parts with the soil; and removing weeds and dead, yellow and sick leaves mixed in the collected sow thistle leaves to obtain trimmed sow thistle leaves for later use;
step S2: cleaning of raw material
soaking and cleaning the trimmed sow thistle leaves with clear water;
step S3: blanching of raw material
boiling the cleaned sow thistle leaves in a hot water bath, then taking the boiled sow thistle leaves out and soaking in water, cooling naturally, and draining the water;
step S4: dehydration of raw material
squeezing the blanched sow thistle leaves until no water flows out, and then drying the sow thistle leaves with hot air;
step S5: preparation of ingredients
peeling and washing the garlic and washing and shredding carrots for later use; and washing and slicing ginger for later use;
step S6: salting
placing the dehydrated sow thistle leaves in a container, adding salt to pickle the sow thistle leaves, and then adding the garlic, shredded carrots and ginger slices, and storing the salted sow thistle leaves with ventilation; and
step S7: low-temperature pickling
re-pickling the pickled sow thistle at a low temperature.

2. The production process for sow thistle according to claim 1, characterized in that, in step S1, sow thistle with a length of 8 to 12 cm is collected.

3. The production process for sow thistle according to claim 1, characterized in that, in step S3, the temperature of the hot water bath is between 60° C. and 80° C., the boiling time is 5-10 min, and the time of soaking in water is 0.5-1 h.

4. The production process for sow thistle according to claim 1, characterized in that, in step S4, the sow thistle leaves are dried with 50° C.-60° C. hot air for 1-2 h.

5. The production process for sow thistle according to claim 1, characterized in that, in step S6, the amount of salt added is 4% to 10% of the weight of sow thistle, the amount of garlic added is 0.03% to 0.05% of the weight of sow thistle, the amount of shredded carrots added is 0.04% to 0.06% of the weight of sow thistle, and the amount of ginger slices added is 0.05% to 0.08% of the weight of sow thistle.

6. The production process for sow thistle according to claim 1, characterized in that, in step S7, the sow thistle is pickled at a temperature of 6° C.-10° C. for 2-3 months.
